(19) United States
(12) Patent Application Publication
(10) Pub. No.: US 2025/0225057 A1
(43) Pub. Date: Jul. 10, 2025

(54) TIMELY SOFTWARE DEFECT PREDICTION METHOD AND SYSTEM BASED ON DEEP LEARNING

(71) Applicant: INDUSTRIAL COOPERATION FOUNDATION JEONBUK NATIONAL UNIVERSITY, Jeonju-si (KR)

(72) Inventors: Ji Won CHOI, Jeonjusi (KR); Tae Young KIM, Jeonjusi (KR); Duk San RYU, Jeonju-si (KR); Jong Moon BAIK, Daejeon (KR); Sun Tae KIM, Jeonju-si (KR)

(21) Appl. No.: 18/609,088

(22) Filed: Mar. 19, 2024

(30) Foreign Application Priority Data
Jan. 9, 2024 (KR) 10-2024-0003566

(51) Int. Cl. G06F 11/36; G06F 40/284; G06F 40/30

(52) U.S. Cl. CPC G06F 11/362; G06F 40/284; G06F 40/30

(57) ABSTRACT

A timely software defect prediction method provided herein includes a data collection step of collecting data, a data labeling step of labeling data with a possibility of generating a defect by using an identification algorithm for the collected data, an embedding step of receiving the labeled data and embedding the labeled data, a learning step of learning context and meaning of the data embedded in the embedding step based on deep learning, and an evaluation step of evaluating a learning result based on the context and meaning of the data learned in the learning step.

### STATEMENT DESIGNATING GRACE PERIOD INVENTOR DISCLOSURES

Applicant informs that the subject matter of this patent application was disclosed by the inventor or by another who obtained the subject matter disclosed directly or indirectly from the inventor or joint inventor one year or less than before the effective filing date of a claimed invention which does not quality as prior art under 35 U.S.C. 102(b)(1), as follows: Jiwon Choi et al., Just-in-Time Defect Prediction for Self-driving Software via Deep Learning Model, Journal of Web Engineering, Vol. 22_2, Jun. 16, 2023.

### TECHNICAL FIELD

The present invention relates to a timely software defect prediction method and system based on deep learning.

### BACKGROUND ART

Edge computing is applied to a variety of applications, for example, autonomous driving software. Autonomous driving is performed by calculating data collected from traffic information and providing the collected data to other vehicles. An autonomous driving system provides AI-based services by collecting and processing large amounts of sensor data and transmit the processed data to other vehicles by using 5G network-based edge computing technology.

Due to complexity of the autonomous driving system and an increase in the proportion of software, various types of software defect accidents occur. However, it is difficult to find an effective solution for predicting and responding in a timely manner to software defects of edge computing applications.

Since autonomous driving software is directly related to passenger safety, it is very important to find defects and increase reliability. Therefore, in order to solve the difficulty of identifying defects in autonomous driving systems, it is necessary to utilize an effective software defect prediction method.

### DISCLOSURE

### Technical Problem

An object to be achieved by the present invention is to provide a timely software defect prediction method and system based on deep learning that may effectively predict a software defect in a timely manner.

### Technical Solution

A timely software defect prediction method according to one embodiment of the present invention includes a data collection step of collecting data on software, a data labeling step of labeling data with a possibility of generating a defect by using an identification algorithm for the collected data, an embedding step of receiving the labeled data and embedding the labeled data, a learning step of learning context and meaning of the data embedded in the embedding step based on deep learning, and an evaluation step of evaluating a learning result based on the context and meaning of the data learned in the learning step.

In the data labeling step according to one embodiment of the present invention, the collected data may include commit data and code change data.

In the data labeling step according to one embodiment of the present invention, the identification algorithm may be an algorithm for automatically identifying change data that causes a defect.

The identification algorithm according to one embodiment of the present invention may include a step of searching for a keyword of the defect-causing change data and identifying a commit corresponding to the keyword, a step of identifying changed code lines of a previous version and a modified version in the commit corresponding to the keyword, a step of generating a change by performing at least one of modification and deletion of a code line in a previous modification for a last commit of commits corresponding to the identified code lines, and a step of labeling the commit data subject to the change as defective and the commit data not subject to the change as defect-free.

The identification algorithm according to one embodiment of the present invention may include an SZZ algorithm.

In the embedding step according to one embodiment of the present invention, embedding may be performed by considering context and semantics, a hierarchical structure and semantic information of a source code, and a relationship between a commit message and a code change by using a pre-trained embedding model based on the commit data and the code change data.

The embedding model according to one embodiment of the present invention may include UniXCoder.

The timely software defect prediction method according to one embodiment of the present invention may further include a preprocessing step of performing preprocessing for tokenization on the commit data and the code change data before the embedding step.

In the learning step according to one embodiment of the present invention, context and meaning of the embedded data may be learned based on deep learning by using a two-way learning model capable of learning a relationship between previous data and subsequent data for the embedded data.

The two-way learning model according to one embodiment of the present invention may include a Bi-LSTM model.

The evaluation step according to one embodiment of the present invention may include a step of generating new another learning data capable of being represented by combining the commit data and the code change data, both learned during the learning step, into one, a classification learning step of learning of classification by using the new another learning data, and a classification learning evaluation step of evaluating the learning of the classification by using a loss function.

The timely software defect prediction method according to one embodiment of the present invention may further include a step of outputting the evaluated final data.

In the timely software defect prediction method according to one embodiment of the present invention, the software may be an edge computing application.

### Advantageous Effects

According to embodiments of the present invention, software defects may be effectively identified at a development stage.

According to embodiments of the present invention, software defects may be effectively predicted.

According to embodiments of the present invention, the quality of software may be effectively increased.

### DESCRIPTION OF DRAWINGS

FIG. 1 is a block diagram illustrating a timely software defect prediction system according to an embodiment of the present invention.

FIG. 2 is a flowchart illustrating a timely software defect prediction method according to an embodiment of the present invention.

FIG. 3 is a conceptual diagram specifically illustrating part of a timely software defect prediction method according to an embodiment of the present invention.

FIG. 4 is a conceptual diagram specifically illustrating another part of a timely software defect prediction method according to an embodiment of the present invention.

### BEST MODE

A timely software defect prediction method according to one embodiment of the present invention includes a data collection step of collecting data on software, a data labeling step of labeling data with a possibility of generating a defect by using an identification algorithm for the collected data, an embedding step of receiving the labeled data and embedding the labeled data, a learning step of learning context and meaning of the data embedded in the embedding step based on deep learning, and an evaluation step of evaluating a learning result based on the context and meaning of the data learned in the learning step.

### MODE FOR INVENTION

Hereinafter, preferred embodiments of the present invention will be described in detail with reference to the accompanying drawings such that those skilled in the art may easily implement the present invention. However, the present invention may be implemented in various different forms and is not limited or restricted by following examples.

In order to clearly describe the present invention, detailed descriptions of parts unrelated to the description or related known technologies that may unnecessarily obscure the gist of the present invention are omitted, and in adding reference signs to components in respective drawings of the present specification, the same or similar reference numerals are given to the same or similar components throughout the specification.

In addition, terms or words used in the present specification and patent claims should not be construed as limited to their usual or dictionary meanings and should be interpreted with meaning and concept consistent with the technical idea of the present invention based on the principle that an inventor may appropriately define the concept of the terms to describe the present invention in the best way.

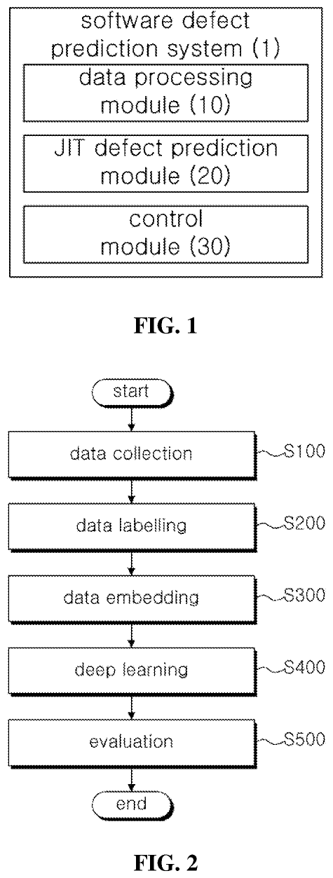

FIG. 1 is a block diagram illustrating a timely software defect prediction system according to an embodiment of the present invention.

The timely software defect prediction system 1 is a system that may identify a software defects during a software development step. The timely software defect prediction system 1 may perform timely defect prediction of an edge computing application.

The timely software defect prediction system 1 may include a data processing module 10.

The data processing module 10 may externally collect data on software and perform labeling on the collected data.

The timely software defect prediction system 1 may include a JIT (Just In Time) defect prediction module 20.

The JIT defect prediction module 20 may perform embedding on labeled data, perform deep learning on the embedded data, and evaluate a learning result using deep learning.

The timely software defect prediction system 1 may include a control module 30.

The control module 30 may be electrically connected to the data processing module 10 and the JIT defect prediction module 20. The control module 30 may control the data processing module 10 and the JIT defect prediction module 20. Operation steps of the data processing module 10 and the JIT defect prediction module 20, which are described below, may be understood as being controlled by the control module 30.

FIG. 2 is a flowchart illustrating a timely software defect prediction method according to an embodiment of the present invention.

The timely software defect prediction system 1 may identify a software defect and perform timely defect prediction through a timely software defect prediction method to be described below.

The timely software defect prediction method may include a data collection step according to S100.

The data collection step may be a step of collecting data from outside. The data may be data on software. Specifically, the software may be an edge computing application but is not limited thereto.

The data collection step may be performed by the data processing module 10. However, the present invention is not limited thereto.

The timely software defect prediction method may include a data labeling step according to S200.

The data labeling step may be a step of labeling data in which defects are likely to occur, by using an identification algorithm for the collected data.

The data labeling step may be performed by the data processing module 10. However, the present invention is not limited thereto.

The timely software defect prediction method may include a data embedding step according to S300.

The embedding step may be a step of receiving labeled data from the data labeling step and performing embedding.

The embedding step may be performed by the JIT defect prediction module 20. However, the present invention is not limited thereto.

The timely software defect prediction method may include a deep learning step according to S400.

The learning step may be a step of learning context and meaning of the data embedded in the embedding step based on deep learning.

The learning step may be performed by the JIT defect prediction module 20. However, the present invention is not limited thereto.

The timely software defect prediction method may include an evaluation step according to S500.

The evaluation step may be a step of evaluating a learning result based on learning data learned in the learning step.

The evaluation step may be performed by the JIT defect prediction module 20. However, the present invention is not limited thereto.

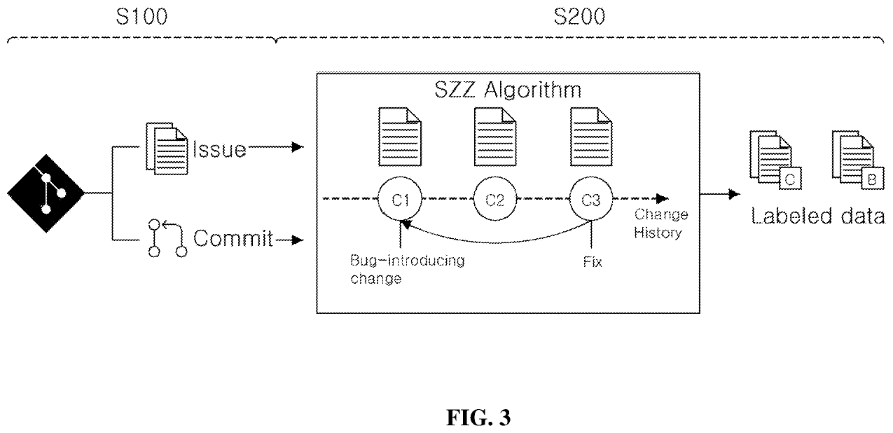

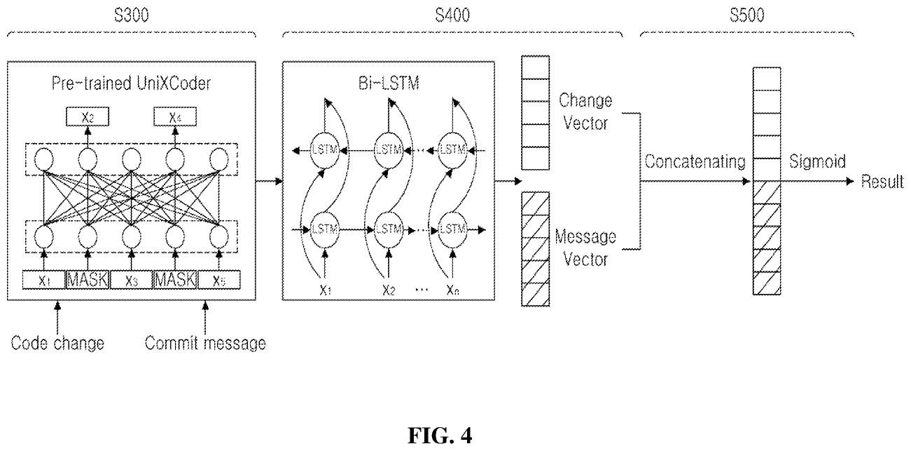

More specific operations of S100 to S500 described above are described below with reference to FIGS. 3 and 4.

FIG. 3 specifically illustrates part (S100 to S200) of the timely software defect prediction method according to the embodiment of the present invention.

In the data collection step according to S100, the data processing module 10 may collect commit data from open source autonomous driving software. The data processing module 10 may collect a commit message and a code change by using PYDRILLER.

The data processing module 10 may collect data of the autonomous driving software.

In the data labeling step according to S200, the collected data of the data processing module 10 may include commit data and code change data.

In the data labeling step, an identification algorithm may be an algorithm for automatically identifying change data that causes defects.

Specifically, the identification algorithm may include steps to be described below.

The identification algorithm may include a step of searching a keyword of the change data and identifying a commit corresponding to the keyword.

The identification algorithm may include a step of identifying changed code lines of the previous version and the modified version from the commit corresponding to the keyword.

The identification algorithm may include a step of generating a change by performing at least one of modification and deletion of a code line in a previous modification for the last commit of commits corresponding to the identified code lines.

The identification algorithm may include a step of labeling the commit data subject to the change as defective and the commit data not subject to the change as defect-free.

The identification algorithm may include an SZZ algorithm. Specifically, the identification algorithm may be an MA-SZZ algorithm of the SZZ algorithm. The general content of the SZZ algorithm may be used for more specific description on the SZZ algorithm.

FIG. 4 specifically illustrates another part (S300 to S500) of the timely software defect prediction method according to the embodiment of the present invention.

File-level defect prediction is generally performed prior to an integration test step, while commit-level defect prediction of the JIT defect prediction module 20 may be performed after each file is changed in an implementation step. The JIT defect prediction of the JIT defect prediction module 20 may be performed at a commit level, that is, a defect may be predicted at a more detailed level than a file level.

A commit is usually less than a file, and accordingly, the amount of code to be inspected may be reduced by identifying a defect. A developer may submit a modified code to a repository while simultaneously checking whether a commit has a defect, and accordingly, the time and effort for inspecting code to find defects may be reduced.

Commit-level defect prediction may be applied at an implementation step and help a developer to identify a defect in a situation where the developer remembers details of the code, and accordingly, the defect may be predicted and modified in a timely manner unlike the file-level defect prediction.

The JIT defect prediction module 20 may be suitable for autonomous driving software by utilizing hierarchical and semantic information (e.g., characteristics of a programming language) of source code in terms of input data.

In the embedding step according to S300, embedding may be performed by considering context and semantics, a hierarchical structure and semantic information of a source code, and a relationship between a commit message and a code change by using a pre-trained embedding model based on commit data (e.g., a code change in FIG. 4) and code change data (e.g., a commit change in FIG. 4). When the embedding is performed, embedding data may be generated.

The embedding model may include UniXCoder. The UniXCoder may be a pre-trained integrated cross-modal pre-trained model. The UniXCoder may process both commit message (natural language) and code change (programming language).

The timely software defect prediction method may further include a preprocessing step of performing preprocessing for tokenization on commit data and code change data before the embedding step.

In the learning step according to S400, the context and meaning of the embedded data may be learned based on deep learning by using a two-way learning model capable of learning a relationship between previous data and subsequent data for the embedded data.

The two-way learning model may include a Bi-LSTM model.

The two-way learning model may assist effective sending of information on the commit message and code change to a classifier. The classifier may perform an evaluation step described below.

The evaluation step according to S500 may include steps described below.

The evaluation step may include a step of generating new learning data that may be represented by concatenating the learned commit data (e.g., a message vector in FIG. 4) and code change data (e.g., a change vector in FIG. 4).

The evaluation step may include a classification learning step in which learning for classification is performed by using new learning data.

The evaluation step may include a classification learning evaluation step of evaluating learning for classification by using a loss function (e.g., sigmoid).

The timely software defect prediction method may include a step of outputting final evaluated data (result of FIG. 4).

The timely software defect prediction method and system described above may be effective in increasing the quality of software under development by reducing the effort of a developer to inspect or test code.

In the present invention, in order to perform JIT defect prediction of autonomous driving software, autonomous driving software data was collected and labeled, and a hierarchical structure and semantic information were inserted to perform defect prediction. This is groundbreaking in enhancing defect prediction performance, and the proposed method outperforms the known machine learning models and state-of-the-art approaches, especially reducing code inspection efforts.

Specifically, a combination of a commit message and a code change reduces code inspection effort, and a combination of commit-level functions enables excellent performance even in evaluation index in which code inspection effort is not considered.

Also, as the context and meaning learning step of the method proposed by the present invention enhance defect prediction performance, a defect of autonomous driving software may be identified in a development step and, as a result, software quality may be increased.

Although the present invention is described above with limited embodiments and drawings, the present invention is not limited thereto, and various implementations may be made by those skilled in the art to which the present invention pertains, within the technical idea of the present invention and the scope of equivalence of the claims described below.

### REFERENCE SIGNS LIST

1: Timely software defect prediction system
10: Data processing module
20: JIT defect prediction module
30: control module

1. A software defect prediction method comprising:
a data collection step of collecting data on software;
a data labeling step of labeling data with a possibility of generating a defect by using an identification algorithm for the collected data;
an embedding step of receiving the labeled data and embedding the labeled data;
a learning step of learning context and meaning of the data embedded in the embedding step based on deep learning; and
an evaluation step of evaluating a learning result based on the context and meaning of the data learned in the learning step.

2. The software defect prediction method of claim 1, wherein
in the data labeling step, the collected data includes commit data and code change data.

3. The software defect prediction method of claim 2, wherein
in the data labeling step, the identification algorithm is configured for automatically identifying defect-causing change data.

4. The software defect prediction method of claim 3, wherein
the identification algorithm includes:
a step of searching for a keyword of the defect-causing change data and identifying a commit corresponding to the keyword;
a step of identifying changed code lines of a previous version and a modified version in the commit corresponding to the keyword;
a step of generating a change by performing at least one of modification and deletion of a code line in a previous modification for a last commit of commits corresponding to the identified code lines; and
a step of labeling the commit data subject to the change as defective, and the commit data not subject to the change as defect-free.

5. The software defect prediction method of claim 3, wherein
the identification algorithm includes an SZZ algorithm.

6. The software defect prediction method of claim 2, wherein
in the embedding step, the embedding is performed by considering context and semantics, a hierarchical structure and semantic information of a source code, and a relationship between a commit message and a code change by using a pre-trained embedding model based on the commit data and the code change data.

7. The software defect prediction method of claim 6, wherein
the embedding model includes a UniXCoder model.

8. The software defect prediction method of claim 6, further comprising:
a preprocessing step of preprocessing for tokenization on the commit data and the code change data before the embedding step.

9. The software defect prediction method of claim 6, wherein
in the learning step, the context and meaning of the embedded data are learned based on the deep learning by using a two-way learning model capable of learning a relationship between previous data and subsequent data for the embedded data.

10. The software defect prediction method of claim 9, wherein
the two-way learning model includes a Bi-LSTM model.

11. The software defect prediction method of claim 2, wherein the evaluation step includes:
a step of generating another learning data represented by combining the commit data and the code change data, both learned during the learning step, into one;
a classification learning step of learning of classification by using the another learning data; and
a classification learning evaluation step of evaluating the learning of the classification by using a loss function.

12. The software defect prediction method of claim 1, further comprising:
a step of outputting final data based on the evaluation step.

13. The software defect prediction method of claim 1, wherein
the software includes an edge computing application.
